(19) United States
(12) Patent Application Publication
(10) Pub. No.: US 2013/0165576 A1
(43) Pub. Date: Jun. 27, 2013

(54) Bracket for Protecting Liquid Crystal Display (LCD) of Portable Display Device

(71) Applicant: Cheil Industries Inc., Gumi-si (KR)

(72) Inventors: Chan Gyun SHIN, Uiwang-si (KR); Yoon Sook LIM, Uiwang-si (KR); Jee Kwon PARK, Uiwang-si (KR); Doo Young KIM, Uiwang-si (KR); Kang Yeol PARK, Uiwang-si (KR)

(73) Assignee: CHEIL INDUSTRIES INC., Gumi-si (KR)

(21) Appl. No.: 13/770,239

(22) Filed: Feb. 19, 2013

Related U.S. Application Data
(63) Continuation-in-part of application No. PCT/KR2010/009245, filed on Dec. 23, 2010.

(30) Foreign Application Priority Data
Aug. 20, 2010 (KR) 10-2010-0081076
Dec. 17, 2010 (KR) 10-2010-0130087

(51) Int. Cl. C08K 3/04

(52) U.S. Cl. CPC C08K 3/04
USPC 524/495; 524/606; 264/299

(57) ABSTRACT

A bracket for protecting the liquid crystal display (LCD) of a portable display device comprises (A) a polyamide resin, and (B) a carbon fiber, wherein the ratio of (A):(B) of the (A) polyamide resin and the (B) carbon fiber is about 20 to about 40 wt %: about 60 to about 80 wt %, and the (A) polyamide resin comprises (a1) an aromatic polyamide and (a2) an aliphatic polyamide including a C₁₀ to C₂₀ aliphatic group.

### CROSS-REFERENCE TO RELATED APPLICATIONS

This application is a continuation-in-part of International Application No. PCT/KR2010/009245 filed on Dec. 23, 2010, pending, which designates the U.S., published as WO 2012/023671, and is incorporated herein by reference in its entirety, and claims priority therefrom under 35 USC Section 120. This application also claims priority under 35 USC Section 119 to and the benefit of Korean Patent Application No. 10-2010-0081076 filed on Aug. 20, 2010, and Korean Patent Application No. 10-2010-0130087 filed on Dec. 17, 2010, the entire disclosure of each of which is incorporated herein by reference.

### FIELD OF THE INVENTION

The present invention relates to a bracket for protecting a liquid crystal display (LCD) of a portable display device and a method of manufacturing the same.

### BACKGROUND OF THE INVENTION

Brackets for IT products act as a frame for LCD protection and EMI shielding and should have high rigidity and EMI shielding capability. Recently, metallic materials such as magnesium, aluminum, stainless steel, and the like have been used for brackets, frames, and the like. In particular, a lightweight metal such as magnesium is generally used for portable display devices, such as mobile phones, notebook computers, personal digital assistants (PDAs), and other mobile items. However, die-casting is generally used to produce an article from magnesium, and there can be problems associated with the same such as high manufacturing costs and high failure rate.

Accordingly, there have been attempts to replace such metallic materials with thermoplastic materials, which can have good formability and also can provide high precision and good economic feasibility or productivity.

Currently developed resins for replacement of metal have a flexural modulus of FM 20 GPa or less and a degree of EMI shielding of about 30 dB (at 1 GHz), which are lower than the rigidity and the EMI shielding degree of metal. In order to increase flexural modulus of the resin, the fiber content in the resin can be increased. However, a high fiber content in the resin can reduce impact strength and fluidity, can cause difficulty in practical application of the resin due to difficulty in processing the resin, and can result in high surface resistance so that the material may have too low electrical conductivity to be used as materials for electronic devices.

For example, when a polyamide resin is used as a base resin, the resin can result in quality deterioration of products due to low dimension stability and high moisture absorbency of the resin, and it can be difficult to maintain high filler loading with a low fluidity base. Therefore, there is a need for a bracket for LCD protection made of a novel material, which has good fluidity and impact strength while ensuring high filler loading, and exhibits low moisture absorbency and surface resistance to replace existing magnesium materials.

### SUMMARY OF THE INVENTION

The present invention relates to a bracket for protecting an LCD of a display device. The bracket can have excellent mechanical strength, such as flexural modulus and/or impact strength. The bracket of the invention can also have excellent EMI shielding effects. Further, the bracket of the invention can exhibit excellent flexibility, low moisture absorption rate, low surface resistance, and/or dimensional stability. The bracket can also exhibit high fluidity and/or good molding precision. Still further, the bracket can be used as a replacement for existing magnesium-based materials.

The present invention also provides a method of manufacturing the bracket for protecting an LCD of a display device. The method of the invention can reduce manufacturing costs, can eliminate post-processing steps, and/or can provide good economic feasibility and productivity. The method of manufacturing a bracket for LCD protection can provide a bracket with an excellent balance of physical properties such as fluidity, impact strength, rigidity, electrical conductivity, dimensional stability and/or EMI shielding capability.

The bracket for protecting an LCD of a portable display device includes: (A) a polyamide resin and (B) carbon fibers, wherein a weight ratio of the (A) polyamide resin to the (B) carbon fibers (A:B) is about 20 to about 40 wt %: about 60 to about 80 wt %, and the (A) polyamide resin includes (a1) an aromatic polyamide and (a2) an aliphatic polyamide including a C₁₀ to C₂₀ aliphatic group.

The (A) polyamide resin may include about 60 wt % to about 95 wt % of the (a1) aromatic polyamide; and about 5 wt % to about 40 wt % of the (a2) aliphatic polyamide.

The (a1) aromatic polyamide may include a wholly aromatic polyamide, a semi-aromatic polyamide, or a combination thereof.

The (a1) aromatic polyamide may include a polymer of an aromatic diamine and an aliphatic dicarboxylic acid.

In some embodiments, the (a1) aromatic polyamide may include one or more polyamides represented by Formula 1:

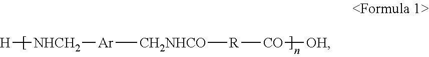

wherein Ar is an aromatic moiety, R is C₄ to C₂₀ alkylene, and n is an integer from 50 to 500.

The (a1) aromatic polyamide may have a glass transition temperature (Tg) of about 80° C. to about 120° C.

The (a2) aliphatic polyamide may have a glass transition temperature (Tg) of about 35° C. to about 50° C.

Examples of the (a2) aliphatic polyamide may include nylon 11, nylon 12, and combinations thereof.

The (B) carbon fibers may have a length of about 1 mm to about 20 mm in pellets.

In some embodiments, the bracket may further include more than about 0 to about 20 parts by weight or less of carbon nanotubes based on about 100 parts by weight of (A)+(B).

The bracket may further include at least one of flame retardants, plasticizers, coupling agents, thermal stabilizers, photo stabilizers, inorganic fillers, mold release agents, dispersants, anti-dripping agents, and weather-proofing stabilizers.

In one embodiment, the bracket may have a spiral flow length of about 40 mm to about 75 mm at 300° C. according to 1 mm standard, an impact strength of about 6 to about 100 J/m at a thickness of 3.2 mm according to ASTM D256, a volume resistance of about 0.01 Ω·cm to about 0.5 Ω·cm according to 100×100 mm standard, a moisture absorption rate of about 1.5% or less, and an EMI shielding value of about 70 dB to about 120 dB at 1 GHz and a thickness of 2 mm according to EMI D257 standard.

In another embodiment, the bracket may have a spiral flow length of about 55 mm to about 75 mm at 300° C. according to 1 mm standard, an impact strength of about 70 J/m to about 100 J/m at a thickness of 3.2 mm according to ASTM D256, a volume resistance of about 0.01 Ω·cm to about 0.2 Ω·cm according to 100×100 mm standard, a moisture absorption rate of about 1.5% or less, and an EMI shielding value of about 75 dB to about 120 dB at 1 GHz and a thickness of 2 mm according to EMI D257 standard.

The present invention also provides a method of manufacturing a bracket for protecting an LCD of a portable display device. The method includes: providing (A) a polyamide resin to an extruder, the (A) polyamide resin comprising about 60 wt % to about 95 wt % of (a1) an aromatic polyamide and about 5 wt % to about 40 wt % of (a2) an aliphatic polyamide including a C₁₀ to C₂₀ aliphatic group; providing (B) carbon fibers to the extruder to impregnate the carbon fibers into the polyamide resin in a weight ratio of the (A) polyamide resin to the (B) carbon fibers (A:B) of about 20 to about 40 wt %: about 60 to about 80 wt %; extruding the impregnated mixture to produce pellets; and molding the pellets.

The impregnation may be carried out by passing the (B) carbon fibers through the (A) polyamide resin in a molten state.

In one embodiment, the (A) polyamide resin and the (B) carbon fibers may be provided to the extruder through the same inlet of the extruder. In another embodiment, the (A) polyamide resin and the (B) carbon fibers may be provided to the extruder through different inlets of the extruder.

In some embodiments, the pellets may have a length of about 5.5 mm to about 25 mm.

The (B) carbon fibers may have the same length as the pellets.

In one embodiment, the impregnated mixture may be subjected to extrusion and cutting to produce pellets.

The present invention also provides a bracket for protecting an LCD of a portable display device. The bracket is made of a material that can have good properties, such as high modulus, high impact strength, low moisture absorption rate, low surface resistance suitable for EMI shielding, high fluidity, good molding precision, good economic feasibility and productivity and/or dimensional stability, can permit elimination of post-processing, and/or can be capable of replacing existing magnesium-based materials, and a method of manufacturing the same.

### BRIEF DESCRIPTION OF DRAWINGS

FIG. 1 is a schematic view of a bracket for protecting an LCD of a portable display device in accordance with one exemplary embodiment of the present invention.

### DETAILED DESCRIPTION OF THE INVENTION

The present invention now will be described more fully hereinafter in the following detailed description of the invention, in which some, but not all embodiments of the invention are described with reference to the accompanying drawings. Indeed, this invention may be embodied in many different forms and should not be construed as limited to the embodiments set forth herein; rather, these embodiments are provided so that this disclosure will satisfy applicable legal requirements.

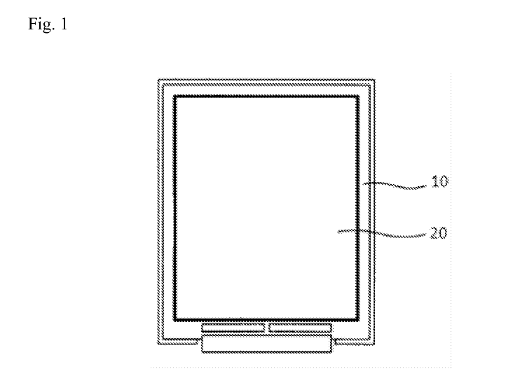

FIG. 1 is a schematic view of a bracket for protecting an LCD of a portable display device in accordance with one embodiment of the present invention. As shown in this figure, the bracket for LCD protection includes an opening 20 through which an LCD is exposed, and a frame 10 configured to secure the LCD around the opening 20. The frame 10 is placed on an upper or lower surface of an LCD module and protects the LCD from impact while shielding electromagnetic waves. The bracket for LCD protection according to the present invention may have various configurations without being limited to the configuration shown in the drawing.

According to the present invention, the bracket for LCD protection includes (A) a polyamide resin and (B) carbon fibers, wherein the (B) carbon fibers are impregnated into the (A) polyamide resin.

The (A) polyamide resin and the (B) carbon fibers are mixed in a weight ratio of (A):(B) of about 20 to about 40 wt %: about 60 to about 80 wt %.

In some embodiments, the polyamide resin (A) can be present in an amount of about 20, 21, 22, 23, 24, 25, 26, 27, 28, 29, 30, 31, 32, 33, 34, 35, 36, 37, 38, 39, or 40 wt %. Further, according to some embodiments of the present invention, the amount of polyamide resin (A) can be in a range from about any of the foregoing amounts to about any other of the foregoing amounts.

In some embodiments, the carbon fibers (B) can be present in an amount of about 60, 61, 62, 63, 64, 65, 66, 67, 68, 69, 70, 71, 72, 73, 74, 75, 76, 77, 78, 79, or 80 wt %. Further, according to some embodiments of the present invention, the amount of carbon fibers (B) can be in a range from about any of the foregoing amounts to about any other of the foregoing amounts.

If the amount of the (B) carbon fibers is less than about 60 wt %, the composition can exhibit a decrease in flexural modulus and flexural strength, increase in volume resistance and moisture absorption rate, and deterioration in EMI shielding capability. In contrast, if the amount of the (B) carbon fibers exceeds about 80 wt %, the composition can exhibit deteriorated fluidity, impact strength and/or flexural strength.

Next, the respective components for the bracket will be described.

(A) Polyamide Resin

According to the present invention, the (A) polyamide resin includes (a1) an aromatic polyamide and (a2) an aliphatic polyamide including a C10 to C20 aliphatic group. In some embodiments, the (A) polyamide resin may include about 60 wt % to about 95 wt % of the (a1) aromatic polyamide and about 5 wt % to about 40 wt % of the (a2) aliphatic polyamide. In some embodiments, the (A) polyamide resin includes 70 wt % to 90 wt % of the (a1) aromatic polyamide and 10 wt % to 30 wt % of the (a2) aliphatic polyamide.

In some embodiments, the polyamide resin (A) can include the (a1) aromatic polyamide in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of (a1) aromatic polyamide can be in a range from about any of the foregoing amounts to about any other of the foregoing amounts.

In some embodiments, the polyamide resin (A) can include the (a2) aliphatic polyamide in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of (a2) aliphatic polyamide can be in a range from about any of the foregoing amounts to about any other of the foregoing amounts.

When the polyamide resin (A) includes the (a1) aromatic polyamide and the (a2) aliphatic polyamide in an amount within the above ranges, the bracket can exhibit an excellent balance between rigidity and fluidity while lowering the moisture absorption rate.

In some embodiments, the ratio of (a1) aromatic polyamide:(a2) aliphatic polyamide including a C10 to C20 aliphatic group ranges from about 2.5:1 to about 5:1, for example about 3:1 to about 4.5:1. Within this range of the composition, the bracket can exhibit an excellent balance between rigidity and fluidity.
(a1) Aromatic Polyamide
The (a1) aromatic polyamide may be a wholly aromatic polyamide, a semi-aromatic polyamide, or a combination thereof. Since the (a1) aromatic polyamide according to the present invention may contain an aromatic moiety in the backbone thereof, it is possible to impart higher rigidity and strength.

The term wholly aromatic polyamide means a polymer of an aromatic diamine and an aromatic dicarboxylic acid.

The term semi-aromatic polyamide means a combination of at least one aromatic moiety and at least one non-aromatic moiety in an amide bond. In one embodiment, the semi-aromatic polyamide may be a polymer of an aromatic diamine and an aliphatic dicarboxylic acid.

In one exemplary embodiment, the (a1) aromatic polyamide may include one or more polyamides represented by Formula 1:

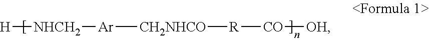

wherein Ar is an aromatic moiety, R is C₄ to C₂₀ alkylene, and n is an integer from 50 to 500.

In Formula 1, Ar may be a substituted or non-substituted aromatic moiety or group. Unless otherwise defined, the term substituted as used herein means that at least one hydrogen atom is a substituted with halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C₁-C₂₀ alkyl group, a C₂-C₂₀ alkenyl group, a C₂-C₂₀ alkynyl group, a C₁-C₂₀ alkoxy group, a C₆-C₃₀ aryl group, a C₆⁻C₃₀ aryloxy group, a C₃-C₃₀ cycloalkyl group, a C₃-C₃₀ cycloalkenyl group, a C₃-C₃₀ cycloalkynyl group, or a combination thereof.

There may be at least one, or more, aromatic moieties or groups.

Unless otherwise defined, the terms aromatic group and/or aromatic moiety as used herein include C6 to C20 aryl.

R may be C₄ to C₂₀ linear or branched alkylene.

In one exemplary embodiment, the semi-aromatic polyamide may be a polymer of an aliphatic diamine and an aromatic dicarboxylic acid, as represented by Formula 2:

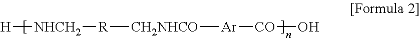

wherein Ar is an aromatic moiety as defined herein, R is C₁ to C₂₀ alkylene, and n is an integer from 50 to 500.

In Formula 2, Ar may be a substituted or non-substituted aromatic moiety. The term substituted is the same as defined herein.

The aromatic polyamide may include at least one, or more, aromatic moieties or groups.

R may be C1 to C20 linear or branched alkylene.

Examples of the aromatic diamine may include without limitation p-xylylenediamine, m-xylylenediamine, and the like. These may be used alone or in combination thereof.

Examples of the aromatic dicarboxylic acid may include without limitation phthalic acid, isophthalic acid, terephthalic acid, naphthalene-2,6-dicarboxylic acid, diphenyl-4,4′-dicarboxylic acid, 1,3-phenylenedioxyacetic acid, and the like. These may be used alone or in combination thereof.

Examples of the aliphatic diamine may include without limitation 1,2-ethylenediamine, 1,3-propylenediamine, 1,6-hexamethylenediamine, 1,12-dodecylenediamine, piperazine, and the like. These may be used alone or in combination thereof.

Examples of the aliphatic dicarboxylic acid may include without limitation adipic acid, sebacic acid, succinic acid, glutaric acid, azelaic acid, dodecanedioic acid, dimer acid, cyclohexanedicarboxylic acid, and the like. These may be used alone or in combination thereof.

In one embodiment, the (a1) aromatic polyamide may have a glass transition temperature (Tg) of about 80° C. to about 120° C., for example about 83° C. to about 100° C. When the (a1) aromatic polyamide has a glass transition temperature (Tg) within this temperature range, the aromatic polyamide can provide an excellent balance of physical properties such as high fluidity and rigidity and low moisture absorbency to the bracket.

Examples of the (a1) aromatic polyamide may include without limitation Nylon MXD6, Nylon 6T, Nylon 9T, Nylon 10T, Nylon 6I/6T, and the like. These may be used alone or in combination thereof.

In addition, the (a1) aromatic polyamide may have a number average molecular weight of about 10,000 g/mol to about 200,000 g/mol, for example about 30,000 g/mol to about 100,000 g/mol. When the (a1) aromatic polyamide has a number average molecular weight within this range, the aromatic polyamide may provide an advantage of facilitating thin film formation and filler impregnation.

(a2) Aliphatic Polyamide

In this invention, the (a2) aliphatic polyamide includes a C₁₀ to C₂₀ aliphatic group. The (a2) aliphatic polyamide may include amino carboxylic acids, such as 10-aminodecanoic acid, 11-aminoundecanoic acid, and 12-aminododecanoic acid, lactams such as laurolactam and cyclododeca lactam, and the like, and combinations thereof, without being limited thereto

In some embodiments, the (a2) aliphatic polyamide may have a glass transition temperature (Tg) of about 35° C. to about 50° C., and a melting point of about 160° C. to about 210° C. When the (a2) aliphatic polyamide has a (Tg) and/or melting point within these ranges, very low moisture absorption rate and excellent impact strength can be obtained.

The (a2) aliphatic polyamide may have a number average molecular weight (Mn) of about 10,000 g/mol to about 200,000 g/mol, for example about 20,000 g/mol to about 150,000 g/mol. When the (a2) aliphatic polyamide has a number average molecular weight within this range, the aliphatic polyamide can provide an advantage of facilitating thin film formation and filler impregnation.

Examples of the (a2) aliphatic polyamide may include without limitation Nylon 11, Nylon 12, and the like, and combinations thereof.

(B) Carbon Fibers

Carbon fibers are well known to those skilled in the art, can be easily commercially obtained, and can be prepared by a typical or conventional method also as known in the art.

In some embodiments, carbon fibers may be PAN and/or pitch-based carbon fibers.

The carbon fibers may have an average diameter of about 1 μm to about 30 μm, for example about 3 μm to about 20 μm, and as another example about 5 μm to about 15 μm. When the carbon fibers have an average diameter within this range, the carbon fibers may provide excellent physical properties and electrical conductivity.

Further, the carbon fibers in a pellet may have a length of about 1 mm to about 20 mm, for example about 5 mm to about 15 mm. When the carbon fibers in a pellet have a length within this range, the carbon fibers may provide an excellent balance between electrical conductivity and mechanical strength.

In some embodiments, the carbon fibers may be subjected to surface treatment and may be prepared in the form of bundles.

According to the present invention, the bracket may further include carbon nanotubes. The carbon nanotubes may be any one of single-walled carbon nanotubes, double-walled carbon nanotubes, multi-walled carbon nanotubes, and combinations thereof. In exemplary embodiments, multi-walled carbon nanotubes can be used. In the bracket, the carbon nanotubes may enable significant reduction of surface resistance while providing better EMI shielding capability and higher rigidity.

The carbon nanotubes may be present in an amount of more than about 0 parts by weight to about 20 parts by weight or less, for example about 0.1 to 15 parts by weight, and as another example about 0.5 to 10 parts by weight, based on about 100 parts by weight of (A)+(B). In some embodiments, the carbon nanotubes may be present in an amount of 0 (carbon nanotubes are not present), about 0 (carbon nanotubes are present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 parts by weight. Further, according to some embodiments of the present invention, the amount of carbon nanotubes can be in a range from about any of the foregoing amounts to about any other of the foregoing amounts.

When the carbon nanotubes are present in an amount within the above range, the carbon nanotubes can provide excellent properties in terms of fluidity, rigidity, and/or EMI shielding capabilities.

According to this invention, the bracket may further include metal fillers. Any metal fillers having electrical conductivity may be used without limitation. In some embodiments, the metal fillers may be formed of aluminum, stainless steel, iron, chromium, nickel, black nickel, copper, silver, gold, platinum, palladium, tin, cobalt, alloys thereof, and the like. These may be used alone or as combinations thereof. In one embodiment, the metal fillers may be iron-chromium-nickel alloy fillers.

In another embodiment, the metal fillers may be metal oxide fillers such as tin oxide, indium oxide, and the like, and/or metal carbide fillers such as silicon carbide, zirconium carbide, titanium carbide, and the like, as well as combinations thereof.

In a further embodiment, the metal fillers may be formed of a low melting point metal, which comprise a main component selected from the group consisting of tin, lead and combinations thereof, and a secondary component selected from the group consisting of copper, aluminum, nickel, silver, germanium, indium, zinc and combinations thereof. The low melting point metal may have a melting point of about 300° C. or less, for example about 275° C. or less, and as another example about 250° C. or less.

The low melting point metal serves to facilitate formation of a network between filler particles, which can further improve EMI shielding efficiency. Such a low melting point metal advantageously has a solidus line temperature (at which solidification of the low melting point metal is finished) lower than a process temperature of the (A) polyamide resin. For example, the low melting point metal can have a solidus line temperature which is lower than the process temperature of the (A) polyamide resin by about 20° C. or more in terms of manufacture of a composite material and formation of the network between fillers, and which is higher than the composite material by about 100° C. or more in terms of stability. For example, the low melting point metal can have a melting point of 300° C. or less, such as tin/copper low melting point metals (for example having a weight ratio of tin/copper of about 90 to about 99 tin/ about 1 to about 10 copper), tin/copper/silver low melting point metals (for example having a weight ratio of tin/copper/silver of about 90 to about 96 tin/ about 3 to about 8 copper/ about 1 to about 3 silver), and the like, and combinations thereof.

The metal fillers may be prepared in the form of metal powder, metal beads, metal fibers, metal flakes, metal-coated particles, metal-coated fibers, and the like, without being limited thereto. These may be used alone or in combination thereof.

When the metal fillers are prepared in the form of metal powder and/or metal beads, the metal fillers may have an average particle diameter of about 30 μm to about 300 μm. When the metal powder and/or metal beads have an average particle diameter within this range, the metal fillers can facilitate feeding upon extrusion.

When the metal fillers are prepared in the form of metal fibers, the metal fillers may have a length of about 50 mm to about 500 mm and a diameter of about 10 μm to about 100 μm. In addition, the metal fibers may have a density of about 0.7 g/ml to about 6.0 g/ml. When the metal fibers have a density within this range, the metal fibers can allow maintenance of a suitable feed rate.

When the metal fillers are prepared in the form of metal flakes, the metal flakes may have an average size of about 50 μm to about 500 μm. When the metal flakes have an average size within this range, the metal flakes may allow a suitable feed rate to be maintained upon extrusion.

The metal powder, metal beads, metal fibers, metal flakes and the like may be composed of a single metal or an alloy of two or more metals, and may have a multilayered structure.

The metal-coated particles and metal-coated fibers may be prepared by coating a core with a metal. The core can be formed of a resin, ceramic, metal, carbon component, and the like, and combinations thereof. For example, the metal-coated particles or metal-coated fibers may be in the form of metal coated resin-based fine particles or fibers wherein the metal may be nickel, nickel-copper, or the like, in which the metal coating may be a single layer or multilayered coating.

In some embodiments, the metal-coated particles may have an average particle diameter of about 30 μm to 300 μm. When the metal-coated particles have an average particle diameter within this range, the metal-coated particles may facilitate feeding upon extrusion.

Further, the metal-coated fibers may have an average diameter of about 10 μm to about 100 μm, and a length of about 50 mm to about 500 mm. When the metal-coated fibers have an average diameter and length within these ranges, the metal-coated fibers may allow a suitable feed rate to be maintained upon extrusion.

In the present invention, the metal fillers may be present in an amount of about 1 to about 20 parts by weight, for example about 3 to about 15 parts by weight, based on about 100 parts by weight of (A)+(B). In some embodiments, the metal fillers may be present in an amount of about 1, 2, 3, 4, 5, 6, 7, 8, 9, 10, 11, 12, 13, 14, 15, 16, 17, 18, 19, or 20 parts by weight. Further, according to some embodiments of the present invention, the amount of metal fillers can be in a range from about any of the foregoing amounts to about any other of the foregoing amounts.

When the metal fillers are present in an amount within this range, the metal fillers may provide a desirable balance between electrical conductivity, fluidity, impact strength, and/or flexural modulus.

In one embodiment, the ratio of the carbon fibers to the metal fillers (carbon fiber:metal filler) may range from about 6:1 to about 20:1, for example about 10:1 to about 16:1. Within this range, it is possible to obtain an excellent balance of physical properties.

According to the present invention, the bracket may further include metal-coated graphite. The metal-coated graphite may be prepared in the form of particles, fibers, flakes, amorphous graphite, and the like, and combinations thereof. When the metal-coated graphite is prepared in the form of fibers, the metal-coated graphite fibers may form a network structure together with the carbon fibers. In this way, when the bracket includes the metal-coated graphite, the bracket may have significantly low surface resistance, further improved EMI shielding capability, and/or higher rigidity.

The metal-coated graphite may have an average diameter of about 10 μm to about 200 μm. Further, when the metal-coated graphite is prepared in the form of fibers, the metal-coated graphite fibers may have an average diameter of about 10 μm to about 200 μm and an average length of about 15 mm to about 100 mm. When the metal-coated graphite fibers have am average diameter and length within these ranges, the metal-coated graphite fibers may provide excellent electrical conductivity while preventing deterioration in mechanical properties.

In some embodiments, any metal having conductivity may be used for coating graphite. Examples of the metal for coating graphite may include without limitation aluminum, stainless steel, iron, chromium, nickel, black nickel, copper, silver, gold, platinum, palladium, tin, cobalt, alloys thereof, and the like, and combinations thereof.

Further, the metal coating may be a single layer or multi-layered coating.

In some embodiments, the metal-coated graphite may be present in an amount of about 10 parts by weight or less, for example about 0.1 to about 7 parts by weight, based on about 100 parts by weight of (A)+(B). In some embodiments, the metal-coated graphite may be present in an amount of 0 (metal-coated graphite is not present), about 0 (metal-coated graphite is present), 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of metal-coated graphite can be in a range from about any of the foregoing amounts to about any other of the foregoing amounts.

In other embodiments, the metal-coated graphite may be used together with the carbon nanotubes. In this case, the metal-coated graphite may be present in an amount of about 0.1 to 10 parts by weight, for example about 1 to 5 parts by weight, based on about 100 parts by weight of (A)+(B). In some embodiments including both metal-coated graphite and carbon nanotubes, the metal-coated graphite may be present in an amount of about 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the amount of metal-coated graphite can be in a range from about any of the foregoing amounts to about any other of the foregoing amounts.

When the metal-coated graphite is used in an amount within this range, the metal-coated graphite may provide excellent properties in terms of fluidity, rigidity, and EMI shielding capability.

According to the present invention, the bracket may include a typical or conventional amount of one or more additives. Examples of additives include without limitation flame retardants, plasticizers, coupling agents, heat stabilizers, photo stabilizers, carbon fillers, inorganic fillers, release agents, dispersants, anti-dripping agents, weather-proofing stabilizers, and the like, and combinations thereof.

As to the carbon fillers, various carbon fillers other than (different from) the (B) carbon fibers may be used. Examples of the carbon fillers may include without limitation graphite, carbon nanotubes, carbon black, metal-coated products thereof, and the like, and combinations thereof. For example, the carbon fillers may include the aforementioned metal-coated graphite.

In addition, examples of the inorganic fillers may include without limitation the aforementioned metal fillers, metal oxide fillers, metal salt fillers, and the like, and combinations thereof may be used.

In one embodiment, the bracket may have a spiral flow length of about 40 to about 75 mm at 300° C. according to 1 mm standard, an impact strength of about 6 to about 100 J/m at a thickness of 3.2 mm according to ASTM D256, a volume resistance of about 0.01 to about 0.5 Ω·cm according to 100×100 mm standard, a moisture absorption rate of about 1.5% or less, and an EMI shielding value of about 70 to about 120 dB at 1 GHz and a thickness of 2 mm according to EMI D257 standard. In another embodiment, the bracket may have a spiral flow length of about 55 to about 75 mm at 300° C. according to 1 mm standard, an impact strength of about 70 to about 100 J/m at a thickness of 3.2 mm according to ASTM D256, a volume resistance of about 0.01 to 0.2 Ω·cm according to 100×100 mm standard, a moisture absorption rate of about 1.5% or less, and an EMI shielding value of about 75 to about 120 dB at 1 GHz and a thickness of 2 mm according to EMI D257 standard.

Further, the bracket may include fibers, the average length of which is about 2 mm or more when measured with respect to 100 strands of yarns in a longitudinal direction thereof after maintaining the molded bracket at 550° C. for 1 hour and extracting the fibers from the bracket.

The present invention also provides to a method of manufacturing a bracket for protecting an LCD of a portable display device.

In some embodiments, the method includes providing (A) a polyamide resin comprising (a1) an aromatic polyamide and (a2) an aliphatic polyamide to an extruder; providing (B) carbon fibers to the extruder to impregnate the carbon fibers into the polyamide resin; and extruding the impregnated mixture to produce.

In one embodiment, the (A) polyamide resin and the (B) carbon fibers may be provided to the extruder through the same inlet of the extruder, or may be provided thereto through separate inlets, followed by kneading and pelletizing.

In another embodiment, the (A) polyamide resin may be first provided to and melted in the extruder, and the (B) carbon fibers can then be provided to the melted polymer resin for impregnation. For example, the (B) carbon fibers can be passed through the (A) polyamide resin in a molten state to be impregnated into the resin. This method can prevent fracture of the fibers during kneading when carbon long fibers having a length of greater than about 5 mm are used.

In one embodiment, the impregnated mixture may be extruded into the form of long fibers, and subjected to pelletizing by cutting the long fibers into a constant size. In one embodiment, the long fibers may be cut to a length of about 5.5 mm to about 25 mm, for example about 6 mm to about 20 mm, upon pelletizing. Within this range, the carbon fibers may be maintained in the form of long fibers, which can provide excellent EMI shielding capability and strength.

The prepared pellets may be used to produce a bracket through injection molding, compression, casting, and the like.

Next, the constitution and functions of the present invention will be explained in more detail with reference to the following examples. It should be understood that these examples are provided for illustration only and are not to be in any way construed as limiting the present invention.

Description of details apparent to those skilled in the art will be omitted herein.

### EXAMPLES

The respective components and specifications of the following examples and comparative examples are as follows:

(A) Polyamide Resin

(a1) Aromatic polyamide: A poly(m-xylylene adipamide) (MXD6) resin (T-600, Toyoboseki) having an Sp-value (solubility parameter) of 11.6 and an amino-end group concentration of 87 eq/10⁶ g is used.

(a21) Aliphatic polyamide: PA11 produced by Arkema and having a glass transition temperature of 45° C. is used.

(a22) Aliphatic polyamide: PA12 produced by Arkema and having a glass transition temperature of 40° C. is used.

(a3) Aliphatic polyamide: PA6 produced by BASF is used.

(a4) Aliphatic polyamide: PA66 produced by BASF is used.

(a5) Aromatic polyamide: PA6T produced by DuPont was used.

(B) Carbon fibers: Chopped carbon fibers T008-6 produced by Toray and having an average diameter of 7 μm and a length of 6 mm are used.

(B′) Carbon long fibers: TORAYCA T700S 50C and 1650TEX of Toray are used.

(C) Carbon nanotubes: NC7000 (multi-walled CNT) produced by Nanocyl are used.

(D) Metal-coated graphite: 2805 (Ni:75 wt %, graphite:25 wt %) produced by Sulzer is used.

(E) Metal filler: 97C (97% Sn, 2.5% tin-copper alloy powder as Cu) produced by (Warton metals Limited) is used as metal powder having a low melting point of 300° C. or less.

### Examples 1 to 10

An aromatic polyamide and an aliphatic polyamide are placed in an extruder in amounts as listed in the following Table 1 and melted therein. Then, carbon fibers are passed through the melted mixture to impregnate the carbon fibers into the mixture, followed by pelletizing to produce long pellets. The prepared pellets are subjected to injection molding in a 10 oz injection molding machine to prepare a bracket. Each of the prepared brackets is evaluated as to physical properties according to the following methods, and results are shown in Table 1.

Evaluation Method:

(1) Spiral flow: Spiral flow length (mm) is measured at 300° C. according to 1 mm standard.

(2) Flexural modulus: Flexural modulus is evaluated according to ASTM D790, and results are given in GPa.

(3) Flexural strength: Flexural modulus is evaluated according to ASTM D790, and results are given in MPa. (4) Izod impact strength (unnotched): Izod impact strength is evaluated at 23° C. and a thickness of 3.2 mm according to ASTM D256, and results are given in J/m.

(5) Volume resistance: Volume resistance (Ω·cm) is evaluated according to 100×100 mm standard.

(6) Moisture absorption rate (%): A weight increase rate of a sample is measured after dipping the dried sample in water at 20° C. for 24 hours.

(7) EMI shielding capability (dB): EMI shielding capability is measured with respect to a 2 mm thick sample at 1 GHz according to EMI D257 after leaving the sample at 23° C. and 50% relative humidity (RH) for 24 hours.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| (a1) MXD6 | 30 | 30 | 24 | — | — | 30 | 30 | 30 | 30 | 30 |
| (a21) PA11 | 10 | — | 6 | 10 | — | 10 | 10 | 10 | 10 | 10 |
| (a22) PA12 | — | 10 | — | — | 10 | — | — | — | — | — |
| (a3) PA6 | — | — | — | — | — | — | — | — | — | — |
| (a4) PA66 | — | — | — | — | — | — | — | — | — | — |
| (a5) PA6T | — | — | — | 30 | 30 | — | — | — | — | — |
| (B) Carbon fibers | 60 | — | 70 | 60 | — | 60 | — | 60 | 60 | 60 |
| (B′) Carbon long | | 60 | | | 60 | | 60 | | | |
| fibers | | | | | | | | | | |
| (C) CNT | — | — | — | — | — | 0.5 | — | 0.5 | — | 0.5 |
| (D) Metal-coated | — | — | — | — | — | — | 5 | 5 | — | — |
| graphite | | | | | | | | | | |
| (E) Metal filler | — | — | — | — | — | — | — | — | 5 | 5 |
| Spiral mm | 61 | 58 | 54 | 45 | 41 | 60 | 43 | 44 | 43 | 42 |
| Flexural modulus | 44 | 49 | 46 | 42 | 49 | 44 | 41 | 42 | 41 | 41 |
| Flexural strength | 570 | 610 | 570 | 520 | 590 | 560 | 510 | 520 | 500 | 500 |
| Impact strength | 78 | 79 | 70 | 65 | 68 | 73 | 63 | 63 | 61 | 61 |
| Volume | 0.2 | 0.1 | 0.1 | 0.2 | 0.2 | 0.1 | 0.06 | 0.08 | 0.1 | 0.08 |
| resistance | | | | | | | | | | |
| Moisture | 1.5 | 1.5 | 1.3 | 1.2 | 1.3 | 1.5 | 1.5 | 1.5 | 1.5 | 1.5 |
| absorption rate | | | | | | | | | | |
| EMI shielding | 80 | 83 | 84 | 75 | 80 | 85 | 85 | 85 | 84 | 85 |

As shown in Table 1, the brackets of Examples 1 to 10, including an aliphatic polyamide having high fluidity, low moisture absorbency and low glass transition temperature, permitted high filler loading and allowed migration of the aliphatic polyamide to the surface thereof, thereby reducing moisture absorbency. In particular, the brackets of Examples 1 and 2 exhibit very low moisture absorbency and excellent impact strength.

### Comparative Examples 1 to 14

Brackets are prepared in the same manner as in Example 1 except that the compositions are changed as listed in Table 2.

TABLE 2

| | Comparative Example | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| (a1) MXD6 | 20 | 30 | 40 | 50 | — | — | — | — | — | — | — | 70 | 20 | 20 |
| (a21) PA11 | — | — | — | — | — | — | — | — | — | 40 | — | — | — | — |
| (a22) PA12 | — | — | — | — | — | — | — | — | — | — | 40 | — | — | — |
| (a3) PA6 | — | — | — | — | 40 | 30 | — | — | — | — | — | — | 20 | — |
| (a4) PA66 | — | — | — | — | — | — | — | 40 | 30 | — | — | — | — | 20 |
| (a5) PA6T | — | — | — | — | — | — | 40 | — | — | — | — | — | — | — |
| (B) Carbon fibers | 80 | 70 | 60 | 50 | 60 | 70 | 60 | 60 | 70 | 60 | 60 | 30 | 60 | 60 |
| Spiral mm | 40 | 38 | 34 | 60 | 55 | 50 | 28 | 40 | 48 | 65 | 64 | 89 | 54 | 55 |
| Flexural modulus | 53 | 53 | 45 | 36 | 38 | 44 | 45 | 39 | 46 | 34 | 34 | 23 | 40 | 41 |
| Flexural strength | 530 | 590 | 580 | 450 | 420 | 510 | 520 | 430 | 520 | 385 | 382 | 290 | 520 | 530 |
| Impact strength | 40 | 59 | 52 | 70 | 70 | 73 | 72 | 70 | 72 | 84 | 82 | 100 | 70 | 72 |
| Volume | 0.08 | 0.1 | 0.2 | 1.0 | 0.2 | 0.2 | 0.2 | 0.2 | 0.18 | 0.2 | 0.2 | 8 | 0.2 | 0.2 |
| resistance | | | | | | | | | | | | | | |
| Moisture | 1.2 | 1.8 | 2.3 | 3.0 | 4.2 | 3.5 | 1.2 | 3.9 | 2.8 | 1.0 | 1.0 | 3.5 | 3.1 | 3.2 |
| absorption rate | | | | | | | | | | | | | | |
| EMI Shielding | 80↑ | 80↑ | 80 | 55 | 75 | 80 | 75 | 78 | 80 | 80 | 80 | 35 | 76 | 75 |

As shown in Table 2, the brackets of Comparative Examples 1 to 3, which did not include the aliphatic polyamide, have significantly lowered fluidity and impact strength. In Comparative Example 4 in which 50% of carbon fibers are used and the aliphatic polyamide is not included, the bracket has very low flexural modulus and flexural strength, high moisture absorbency, and very low EMI shielding capability.

In Comparative Examples 5 and 6 in which PA6 is included, the brackets have a moisture absorption rate exceeding 3%, and have low flexural modulus and flexural strength when carbon fibers are loaded in the same amount. In Comparative Example 7, the bracket has a low moisture absorption rate and high flexural strength, but needs a high processing temperature of about 350° C. or more and very low fluidity. In Comparative Examples 8 and 9 in which PA66 is included, the bracket exhibited similar results as those including PA6 and most physical properties are significantly lowered.

In Comparative Examples 10 and 11 in which only an aliphatic polyamide is included without the aromatic polyamide, the brackets have improved fluidity, low moisture absorbency, and high impact strength, but have significantly low flexural modulus and flexural strength. In Comparative Example 12 in which an excess of the aromatic polyamide is used, the bracket has significantly low properties in terms of flexural modulus, flexural strength, and EMI shielding capability.

In Comparative Examples 13 and 14 in which combinations of (a1) MXD6 and (a3) PA6 or (a4) PA66 are used, the brackets have very high moisture absorption rate.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A bracket for protecting an LCD of a portable display device, comprising (A) a polyamide resin and (B) carbon fibers, wherein the ratio of the (A) polyamide resin to the (B) carbon fibers (A:B) is about 20 to about 40 wt %: about 60 to about 80 wt %, and the (A) polyamide resin comprises (a1) an aromatic polyamide and (a2) an aliphatic polyamide including a C₁₀ to C₂₀ aliphatic group.

2. The bracket according to claim 1, wherein the (A) polyamide resin comprises about 60 wt % to about 95 wt % of the (a1) aromatic polyamide; and about 5 wt % to about 40 wt % of the (a2) aliphatic polyamide.

3. The bracket according to claim 1, wherein the (a1) aromatic polyamide comprises a wholly aromatic polyamide, a semi-aromatic polyamide, or a combination thereof.

4. The bracket according to claim 1, wherein the (a1) aromatic polyamide comprises a polymer of an aromatic diamine and an aliphatic dicarboxylic acid.

5. The bracket according to claim 4, wherein the (a1) aromatic polyamide comprises one or more polyamides represented by Formula 1: 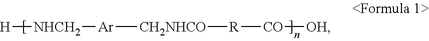
wherein Ar is an aromatic moiety, R is C₄ to C₂₀ alkylene, and n is an integer from 50 to 500.

6. The bracket according to claim 1, wherein the (a1) aromatic polyamide has a glass transition temperature (Tg) of about 80° C. to about 120° C.

7. The bracket according to claim 1, wherein the (a2) aliphatic polyamide has a glass transition temperature (Tg) of about 35° C. to about 50° C.

8. The bracket according to claim 7, wherein the (a2) aliphatic polyamide comprises Nylon 11, Nylon12, or a combination thereof.

9. The bracket according to claim 1, wherein the (B) carbon fibers have a length of about 1 mm to about 20 mm.

10. The bracket according to claim 1, further comprising more than about 0 to about 20 parts by weight of carbon nanotubes based on about 100 parts by weight of (A)+(B).

11. The bracket according to claim 1, further comprising a flame retardant, plasticizer, coupling agent, thermal stabilizer, photo stabilizer, carbon filler which is not the same as carbon fiber (B), inorganic filler, mold release agent, dispersant, anti-dripping agent, weather-proofing stabilizer or a combination thereof.

12. The bracket according to claim 11, wherein the carbon filler comprises graphite, carbon nanotubes, carbon black, metal-coated products thereof, or a combination thereof.

13. The bracket according to claim 11, wherein the inorganic filler comprises metal fillers.

14. The bracket according to claim 1, wherein the bracket has a spiral flow length of about 55 mm to about 75 mm at 300° C. according to 1 mm standard, an impact strength of about 70 J/m to about 100 J/m at a thickness of 3.2 mm according to ASTM D256, a volume resistance of about 0.01 Ω·cm to about 0.5 Ω·cm according to 100×100 mm standard, a moisture absorption rate of about 1.5% or less, and an EMI shielding value of about 70 dB to about 120 dB at 1 GHz and a thickness of 2 mm according to EMI D257 standard.

15. A method of manufacturing a bracket for protecting an LCD of a portable display device, comprising:
providing (A) a polyamide resin to an extruder, the (A) polyamide resin comprising about 60 wt % to about 95 wt % of (a1) an aromatic polyamide and about 5 wt % to about 40 wt % of (a2) an aliphatic polyamide including a C₁₀ to C₂₀ aliphatic group;
providing (B) carbon fibers to the extruder to impregnate the carbon fibers into the polyamide resin in a weight ratio of the (A) polyamide resin to the (B) carbon fibers (A:B) of about 20 to about 40 wt %: about 60 to about 80 wt %;
extruding the impregnated mixture to produce pellets; and
molding the pellets.

16. The method according to claim 15, wherein the impregnation is carried out by passing the (B) carbon fibers through the (A) polyamide resin in a molten state.

17. The method according to claim 15, wherein the pellets have a length of about 5.5 mm to about 25 mm.

18. The method according to claim 15, wherein the (B) carbon fibers have a length of about 1 mm to about 20 mm.

19. The method according to claim 15, wherein the impregnated mixture is subjected to extrusion and cutting to produce pellets.
